(19) United States
(12) Patent Application Publication
(10) Pub. No.: US 2011/0221219 A1
(43) Pub. Date: Sep. 15, 2011

(54) Pneumatic Golf Disc Retriever

(75) Inventor: John Heaton, Lemon Grove, CA (US)

(73) Assignee: WHIRLED SPORTS, Lemon Grove, CA (US)

(21) Appl. No.: 12/718,950

(22) Filed: Mar. 5, 2010

(51) Int. Cl. B25J 1/00; B25J 1/04

(52) U.S. Cl. 294/210

(57) ABSTRACT

A pneumatic golf disc retriever is provided for retrieval of a Frisbee golf disc. The retriever is extendable to a length of 2-meters for determining a present infraction in violation of the disc-golf 2 meter rule. The retriever includes a telescoping extendable shaft which rapidly extends for retrieving a golf disc and similarly retracts for storing and carrying along a golf course. The pneumatic retriever further includes a pneumatic actuator disposed on a proximal end, a suction cup disposed on a distal end, and a stretchable tubing connecting therebetween. The suction cup can further be attached by a hinge.

### FIELD OF THE INVENTION

This invention relates generally to disc golf, also referred to as “frisbee golf”; and more particularly to a pneumatic retriever for retrieving a golf disc or similar article.

### BACKGROUND OF THE INVENTION

The sport of disc golf is well known and recently has gained popularity as an alternative to traditional golf. There are many similarities between a typical golf course and a disc golf course, for example, many of the same hazardous obstacles including: water, trees, and bushes are commonly found. Many golf balls end up in these hazards and are often left behind due to golf players not attempting to retrieve them. However, a golf disc is significantly more expensive than a golf ball, thus there is an increased desire to retrieve the disc. Also, a disc golfer typically has a specific disc for a certain shot therefore losing a disc would partially inhibit game play. There have been many embodiments provided as golf ball retrievers, however, due to the difference of shape, weight, and size between golf balls and golf discs, golf ball retrievers would be ineffective in retrieving golf discs. Currently, there are very few golf disc retrievers available, however the need for these retrievers is growing rapidly with the advancement of the sport of disc golf, also referred to as “frisbee golf”.

Although disc golf and traditional golf have many similar rules, there are some differences. One rule that is unique to disc golf and is of particular importance regarding the present invention is the “2-meter rule”. This rule states that if a disc lands more than 2 meters above the playing surface then there will be a one stroke penalty enforced. The 2 meter rule is currently determined by a users honorable approximation. It would be an added benefit to the sport of disc golf if a retriever was provided that was capable of ascertaining a 2 meter infraction.

U.S. Pat. No. 7,320,489, issued Jan. 22, 2008 to Domb, discloses a golf disc retriever with an elongating handle and a U-shaped, spring actuated assembly for retrieving golf discs from inaccessible places. However, this retriever requires the disc to become wedged in a rigid position. If not wedged in a rigid position with sufficient opposing force, the engaging assembly will push the golf disc further away from the user, effectively ejecting the golf disc in many instances.

U.S. Pat. No. 6,726,265, issued Apr. 27, 2004 to Miller, provides a golf disc retriever having a rope connected to a rectangular frame. The frame can be thrown in front of a golf disc and reeled in while retaining the golf disc. One problem with this retriever is that the embodiment relies heavily on the accuracy of the user in throwing the frame to a proper position for retrieving a disc. Furthermore, this retriever requires a significant amount of time to effectuate the return of a golf disc because the rope has to be wound and unwound for each use. Still further, this embodiment is not capable of shagging a number of discs, where shagging is the method of walking to a position above a first disc, grabbing and retrieving the first disc, then walking to a position above a second disc and repeating for a number of discs.

U.S. Pat. No. 6,705,654, issued Mar. 16, 2004 to Slauf, provides a golf disc retriever with fold-up tubular sections and numerous tools that can be attached at its end. However, this retriever takes up an exorbitant amount of space and is difficult to carry though several hundred yards of a disc golf course. Additionally, the plurality of tools would require the disc golfer to carry more objects, increasing fatigue and inhibiting performance with the added weight.

U.S. Pub. No. 2009/0115211 filed Sep. 9, 2008 by Johnson, provides a golf disc pick up tool with a collapsible segmented shaft and a fixed suction cup at its end. One problem with this example is the bulky folding shaft which is difficult to carry, assemble, utilize, disassemble, store and carry in between retrieval of golf discs. Additionally, this example of a golf disc retriever provides a fixed suction cup which is difficult to effectively attach to a disc in all positions except from directly above. Furthermore, this retriever is not extendable and not pneumatic.

There has yet to be made available a golf disc retriever that requires little space; that can be rapidly expanded and collapsed; that can reliably mount and retain a golf disc from numerous angles; utilizes the strength of a pneumatic system; and also extends to a length of 2 meters to be used as a method of checking whether a violation of the “2-meter rule” has occurred.

### SUMMARY OF THE INVENTION

Accordingly, the present invention provides a pneumatic golf disc retriever for solving these and other problems in the art. The retriever generally includes a multi-section telescoping shaft and an integrated pneumatic system. The pneumatic system further includes a suction cup, a pneumatic actuator, and a stretchable tubing connected therebetween.

A beneficial object of the present invention is to provide a golf disc retriever that extends to a predetermined length to be used as a method of checking whether a violation of the “2-meter rule” has occurred.

Another object of the invention is to provide a rapidly expandable and collapsible golf disc retriever. In one embodiment, the retriever includes a telescoping shaft for rapidly extending and collapsing the retriever.

Another object of the present invention is to provide a golf disc retriever that when compacted occupies minimal space, so that it is easy to carry and transport.

Another object of the present invention is to provide a golf disc retriever having an integrated pneumatic system for mounting and retaining a golf disc from numerous angles and at extended distances of several feet. The pneumatic system can comprise a pneumatic actuator such as a piston pump, pneumatic bulb, or any other vacuum creating pump or article. The pneumatic actuator is generally configured to be in pneumatic communication with the suction cup via elastic tubing or a sealed shaft.

Another object of the present invention is to provide a golf disc retriever that comprises a multi-section shaft having a slot. The slot restricts rotational movement of the telescoping shaft members for providing a user improved accuracy and resilience while using the retriever.

Another object of the present invention is to provide a golf disc retriever having a grip handle for providing a comfortable gripping location for a user.

Another object of the present invention is to provide a golf disc retriever that comprises one or more rings or other mechanism for fixing a desired extended length of the telescoping elongated shaft.

Yet another object of the present invention is to provide a golf disc retriever that comprises a valve for releasing pneumatic pressure from the pneumatic system, the valve providing easy removal or release of a mounted disc golf disc from the pneumatic system.

The golf disc retriever includes an extendable shaft having a proximal end and a distal end. A pneumatic actuator, such as a pneumatic bulb, pump, or other article is attached to the extendable shaft at a proximal end. A suction cup is attached to the distal end of the extendable shaft at a hinge, the suction cup including a port for attaching a pneumatic system. One or more sections of tubing are disposed about the length of the extendable shaft for connecting the pneumatic actuator to the suction cup. The tubing can include an elastic tubing, coiled tubing, or other stretchable tubing for facilitating the extension of the shaft from a first collapsed position to a second extended position. The extendable shaft can further include two or more telescoping sections, and can extend to a 2-meter length for measuring a potential violation of a game regulation. A valve can be integrated with the pneumatic system for providing a quick-release function.

If a disc golfer finds himself in a circumstance where a golf disc is misplaced under water, for example within a water hazard, the retriever allows for gripping of the disc without pushing down and instead by applying pneumatic pressure to vacuum grip the disc to the retriever.

The retriever can further be used for shagging a plurality of golf discs. The retriever can further include an extendable addition for attaching to the proximal end of the retriever.

### BRIEF DESCRIPTION OF THE DRAWINGS

These and other attributes of the invention are further described in the following detailed description of the invention, particularly when reviewed in conjunction with the drawings, wherein:

FIG. 1 is perspective view of an extended golf disc retriever assembly.

FIG. 2 is a perspective view of a collapsed golf disc retriever assembly.

FIG. 3 is an enlarged perspective view of the distal end of the retriever of FIG. 1.

FIG. 4 is a cross sectional view of the distal end of the retriever of FIG. 3.

FIG. 5 is an enlarged perspective view of the proximal end of the retriever of FIG. 1.

FIG. 6 is a cross sectional view of the proximal end of the retriever of FIG. 5.

FIG. 7 is perspective view of a standard golf disc (prior art).

FIG. 8 is a perspective view of the golf disc retriever assembly of FIG. 1 in proximal location with the golf disc of FIG. 7.

FIG. 9 is a side view of the golf disc retriever assembly of FIG. 1 attached to a golf disc.

FIG. 10 is a cross sectional view of the distal end of the retriever assembly and attached disc as illustrated in FIG. 9.

### DETAILED DESCRIPTION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

In a general embodiment, a golf disc retriever is provided for use in a variety of applications, the golf disc retriever includes an elongated shaft, the shaft is extendable from a first collapsed length to a second expanded length. The retriever assembly further includes a pneumatic actuator attached at a proximal end of the shaft, the pneumatic actuator is in pneumatic communication with a suction cup. The suction cup includes at least one port and is hingedly disposed on the distal end of the shaft. The pneumatic actuator can be one of a pneumatic bulb, piston pump, or similar pneumatic article.

In one embodiment, a retriever assembly includes a hollow shaft or “lumen” containing or substantially surrounding an elastic tubing. The elastic tubing extends from a pneumatic bulb disposed on a proximal end of the retriever to a suction cup hingedly disposed on a distal end of the retriever. The shaft includes a first telescoping member and a second telescoping member. The first telescoping member is concentrically disposed with the second telescoping member. The second telescoping member at least partially overlaps the first telescoping member. The first member includes a slot that extends longitudinally thereon. The second member includes a guide that extends radially inward along at least a portion of the length of the second telescoping member. The guide of the second telescoping member is adapted to be received by the slot portion of the first telescoping member, such that the second telescoping member is concentrically disposed and at least partially overlaps with the first telescoping member, and the first and second telescoping members are slideably engaged and rotationally fixed by the slot and guide portions. The slot and guide function to prevent tangling of the pneumatic hose or stretchable hose.

In another embodiment, a means for providing an air-tight pneumatic communication between the pneumatic actuator and the suction cup is achieved with elastic tubing and tube couplings. Alternatively, the air-tight pneumatic communication between the pneumatic actuator and suction cup can be achieved using an adapted multi-section pneumatically sealed shaft and one or more portions of tubing.

The telescoping members of the extendable shaft can be fixed at a desired distance using rings or collars which can be rotationally engaged to create a friction grip between two telescoping members. In an alternative embodiment, a cam lock such as a lever cam lock can be flipped up and down, respectively to release and lock the telescoping members in place. Numerous other mechanisms for fixing the telescoping members at a desired position may also be employed.

In another embodiment, the retriever assembly includes three telescoping members.

In yet another embodiment, the retriever assembly includes four telescoping members.

In another embodiment, the retriever assembly includes a multi-section elongated shaft as described in the general embodiment above, wherein a valve is provided in conjunction with the suction cup for releasing pneumatic pressure. The valve can be disposed substantially near the proximal end of the retriever assembly. Alternatively, the valve can be placed within a users reach along the elongated shaft portion of the retriever.

In another embodiment of the invention, the distal section of the extendable shaft includes an aperture for receiving a fixed tubing portion. The distal section of the extendable shaft can further include a ridge for mounting a coupling assembly. The mounted coupling assembly includes a first connector for attaching a fixed tubing portion, the fixed tubing portion extending from the mounted coupling assembly through the aperture and is attached to the suction cup at a port. A stretchable tubing portion is attached to the second connector of the mounted coupling assembly and extends therefrom along the length of the extendable shaft to attach to a pneumatic actuator. The fixed tubing portion and mounted coupling assembly provide a secure and tension-free tubing section for allowing rotational translation of the suction cup at a hinge. Without the tension-free tubing section, the suction cup would be tensioned by the stretchable tubing portion and would be inhibited by forces relating thereto.

In another embodiment of the invention, a pneumatic chamber is connected to a suction cup at a port; the pneumatic chamber does not include a pneumatic actuator. The pneumatic chamber can be a tubing, or an air-tight pneumatic shaft having an aperture. A user can place a finger over the aperture or at the tip of the tubing to create a seal. The seal created can be used to maintain a disc attached to the suction cup of the golf disc retriever. Upon release of the seal, or removal of the finger from the aperture or tubing, the disc is released from the suction cup.

In yet another embodiment of the invention, an extension shaft can be attached to the cap portion on the proximal end of the pneumatic golf disc retriever. In this embodiment, one or more spring-pin members can be used to affix an extension shaft. The inner diameter of the extension shaft can be slightly larger than the outer diameter of the proximal end of the retriever. The extension shaft can slideably engage concentric with the proximal end of the retriever. The extension shaft can be adapted to further include one or more apertures for receiving said one or more spring pins, and fixing the extension in a secure attachment to the retriever. Similar attachment mechanisms can be used to attach an extension shaft to the golf disc retriever. The extension shaft can further be a telescoping extension shaft.

It has been recognized by the inventor that the pneumatic system is sensitive and must be designed properly or the pneumatic system may not perform effectively with a standard golf disc. Surprising results were found and are disclosed. For example, one of ordinary skill in the art would assume that a suction cup of a particular size and connected to a length of tubing and a pneumatic actuator would be capable of gripping a golf disc, provided that the same particular size suction cup was capable of gripping the disc with less tubing or no tubing at all. One of ordinary skill in the art would underestimate the balance required between the volume of air contained in the pneumatic system and the size of the suction cup. After much experimentation, the inventor of the present application has determined a relationship between the volume of air in the pneumatic system and the suction cup used.

In another embodiment, a camera and LCD display can be incorporated into the retriever. In this embodiment, a camera can be positioned on the distal end of the retriever for viewing beneath murky or clouded water. The display can be positioned at the proximal end for presenting the images received by the attached camera. The camera may further be water-proof.

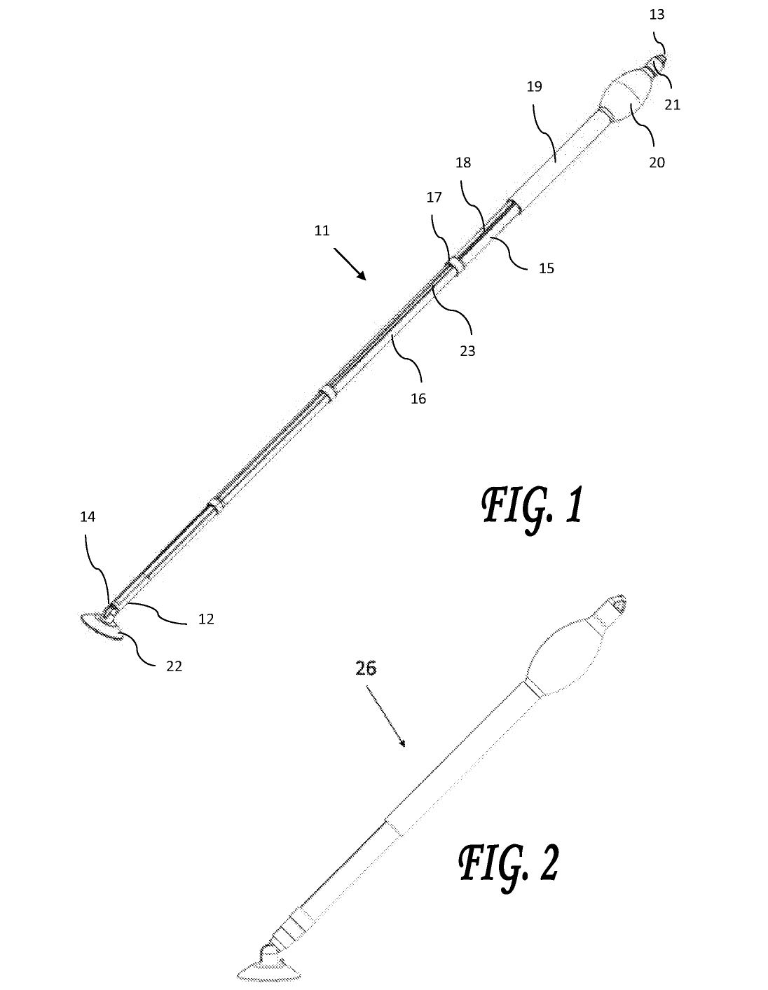

Referring now to the drawings, FIG. 1 illustrates an extended golf disc retriever assembly 11 according to one embodiment of the invention. The retriever assembly 11 includes a multi-section telescoping shaft 15, 16; a proximal end 13; and a distal end 12. The retriever includes a first telescoping member 16 and a second telescoping member. Additional telescoping members are included for providing added length. The second telescoping member at least partially overlaps with the first telescoping member. A concentric ring is disposed between each telescoping member for fixing the telescoping extendable shaft members at a desired extended length. The telescoping members further include a slot extending longitudinally thereon. The slot acts as a track for slideably extending the telescoping expandable shaft. The slot further restricts rotational movement of telescoping members providing resilience and improved accuracy when retrieving a golf disc. The proximal end of the retriever assembly includes a grip, a pneumatic actuator, and a cap. The pneumatic actuator is a pneumatic bulb. The grip is a thin walled cylindrical member overlapping the second telescoping member. The grip maintains contact with the outer diameter of the second telescoping member. The pneumatic actuator is axially disposed on the proximal end of the shaft. The distal end of the retriever assembly includes a suction cup. The length of the retriever assembly is adapted to extend to a predetermined distance of two meters and can be used for determining a game infraction, such as a 2-meter disc golf infraction.

FIG. 2 illustrates a collapsed golf disc retriever assembly 26 according to one embodiment of the invention. The telescoping members of the collapsed retriever assembly overlap to provide a rapidly collapsible retriever body. The collapsed retriever provides convenient attachment to a belt clip, disc bag, or other attachment means. The collapsed retriever is adapted to provide reduced bulk for enabling a disc golfer maximum portability and convenience.

FIG. 3 illustrates the distal end of the retriever assembly according to one embodiment of the invention. The distal end including a suction cup 22, tubing 30, and a distal telescoping member 31. The distal telescoping member 31 includes a body portion and a head portion 36. The head portion 36 having an eyelet shape. The suction cup 22 includes a bottom portion 33 and a top portion 32. The top portion 32 is axially disposed concentric to the bottom portion and includes an extruded cylinder with a round top. The top portion 34 further includes a cavity 34 having a bottom surface and two side walls. The cavity is adapted to receive the head portion 36 of the final telescoping member such that the suction cup 22 is adapted for rotational translation. The suction cup further includes a port for connecting a tubing 30.

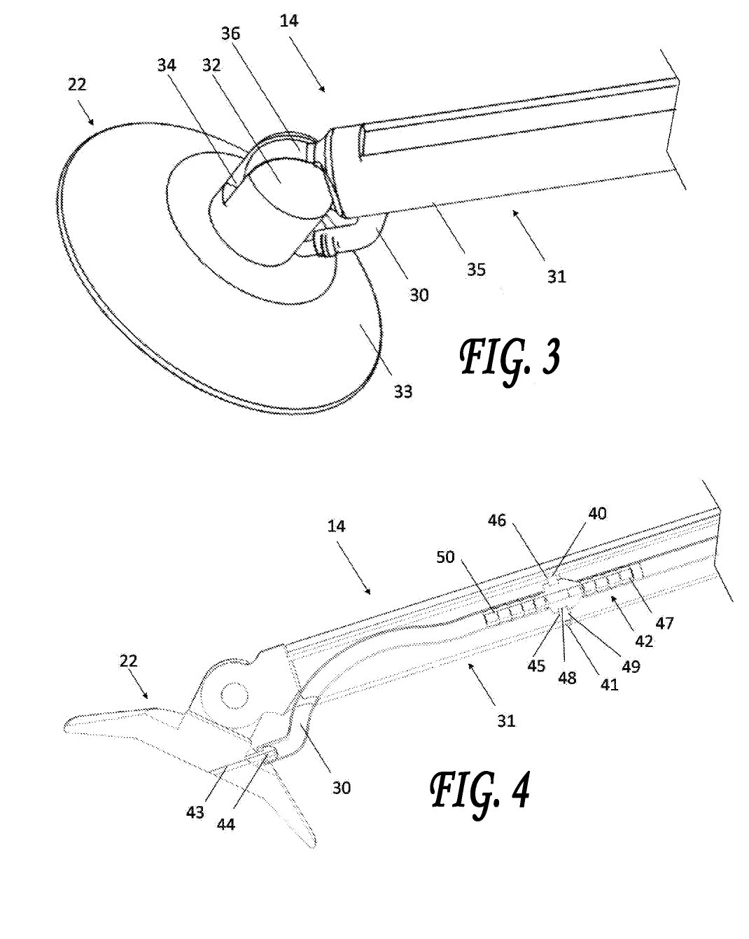

FIG. 4 illustrates a cross-section of the distal end of the retriever assembly. The distal end of the retriever including a washer 49, a first tube coupling 48, elastic tubing, a set screw 41, a distal telescoping member 31, and a suction cup 22. The suction cup 22 further includes a nozzle 43 and a port 44.

As further illustrated in FIG. 4, the head portion of the distal telescoping member 31 is adapted to engage with the cavity of the suction cup such that the suction cup is rationally mounted to form a hinge. The distal telescoping member includes an aperture between the head portion and body portion for receiving a portion of tubing attached to the suction cup. The body portion of the distal telescoping member is adapted to receive a washer 49, tube coupling 48, and tubing. The body portion may further include a concentric ridge, and threaded aperture. The washer is adapted to fit inside and become engaged within the distal telescoping member. The back face of the washer is disposed in contact with the concentric ridge of the body portion of the telescoping member to provide a flush engagement. A set screw is threadedly engaged with a threaded aperture of the telescoping member and contacts the radial face of the washer for providing a secure mount and fixed position. The first tube coupling includes a front connector 50, a rear connector 47, and a recessed portion. The recessed portion is adapted to receive the washer. Elastic tubing is disposed within the lumen of the elongated shaft body portion and connects the pneumatic actuator to the first tube coupling.

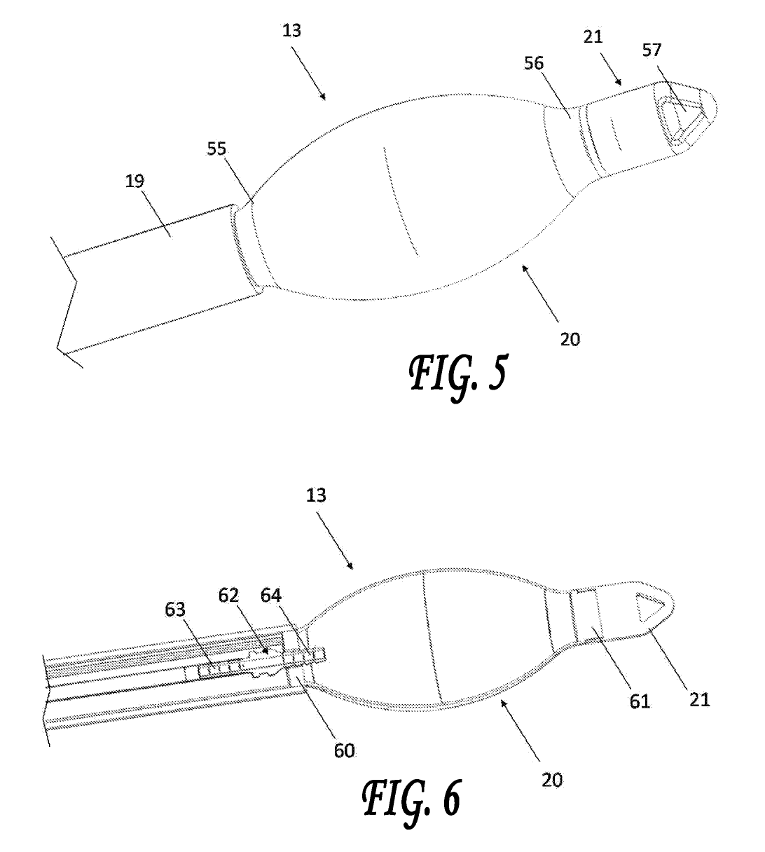

FIG. 5 illustrates the proximal end of the retriever assembly according to one embodiment of the invention. The proximal end including a grip 19, a pneumatic bulb 20, and a cap 21. The cap is aligned and disposed with the rear portion 56 of the pneumatic bulb 20. The cap 21 includes an aperture 57 that can be used for hanging the retriever assembly from a hook or clip. The grip 19 is axially aligned with the front portion 55 of the pneumatic bulb 20.

FIG. 6 illustrates a cross-sectional view of the proximal end of the retriever assembly according to an embodiment of the invention. The retriever further including a second tube coupling 62, elastic tubing disposed within the lumen of the expandable shaft along a length thereof, a telescoping member, a pneumatic bulb 20, a cap 21, and a grip 19. The pneumatic bulb includes a front end, and a rear end; the front end having an aperture for receiving the second tube coupling. The second tube coupling has a front connector 63 and a rear connector 64. The front connector 63 is mounted to provide an air-tight pneumatic connection from the pneumatic bulb to the front connector of the second tube coupling. Elastic, coiled, or otherwise stretchable tubing is attached to the second tube coupling 62 and extends along the length of the shaft to the distal end of the retriever where the opposite end of the tubing is connected to the rear connector of the first tube coupling 47. A valve can be connected to the tubing (not illustrated) or the bulb to provide a mechanism for releasing pressure in the pneumatic system and thereby releasing a disc from the suction cup.

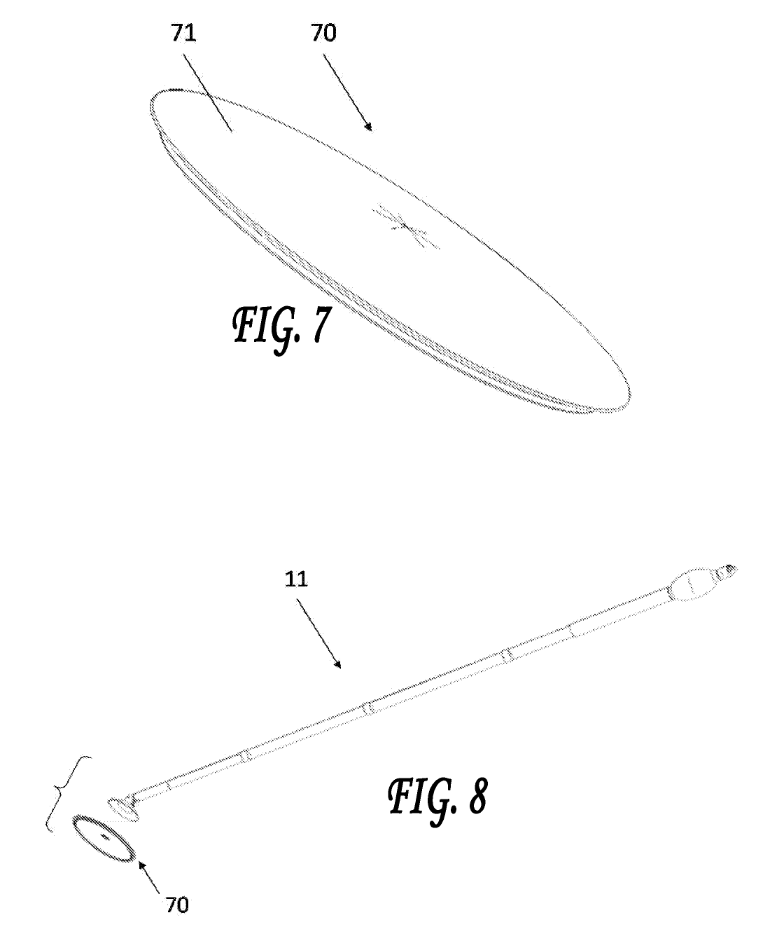

FIG. 7 illustrates a Frisbee golf disc as commonly known in the art. The Frisbee golf disc having a top surface and a bottom surface, the bottom surface shown in FIG. 10 and includes a concave portion.

FIG. 8 illustrates the retriever assembly according to another embodiment where the retriever is used to collect a Frisbee golf disc. The retriever assembly is fully extended to an expanded length and in proximal location to the disc golf disc. A slight press of the pneumatic bulb creates a potential energy useful in creating a vacuum upon sealing a rim of the suction cup to the top surface of the Frisbee golf disc.

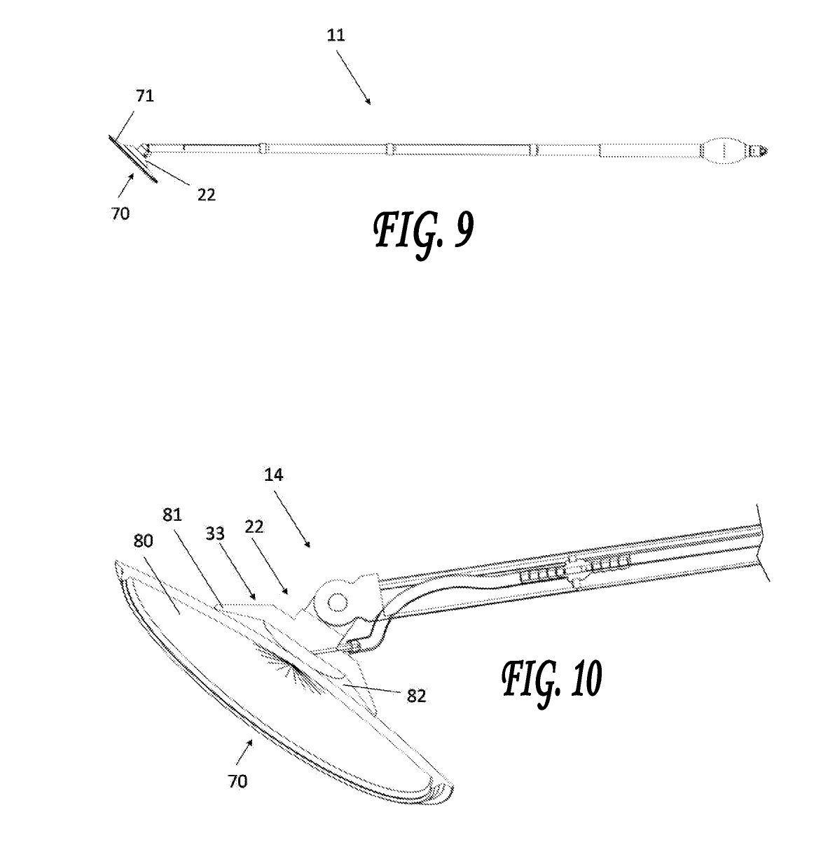

FIG. 9 further illustrates the distal end of the retriever assembly with an attached Frisbee golf disc. The Frisbee golf disc is removably connected to the suction cup of the retriever assembly. The Frisbee golf disc is attached to the suction cup by a pneumatic vacuum pressure created by the pneumatic bulb.

FIG. 10 illustrates a cross-sectional view of the retriever assembly and attached golf disc. The retriever includes a suction cup 22, and a golf disc 80. The suction cup having a body portion that includes an extended rim 81. A user can physically compress the pneumatic bulb, reducing the volume of the air-tight region created by the elastic tubing, tube couplings, pneumatic bulb, and suction cup, thus releasing air. The user can then press the pneumatic bulb to create a vacuum; press the extended rim of the suction cup onto a golf disc such that an enclosed air-tight cavity is created. The vacuum created by releasing the pneumatic bulb then provides a means for pneumatically gripping the golf disc to the retriever assembly.

Although several detailed examples are provided above, it should be understood by one having skill in the art that various combinations and deviations from these examples can be pursued to provide substantially similar results. The above examples are set forth for illustrative purposes and are not intended to limit the spirit and scope of the invention.

What is claimed is:

1. A golf disc retriever, comprising:
an elongated shaft extendable from a first collapsed length to a second expanded length;
a pneumatic bulb attached to said elongated shaft at a proximal end; and
a suction cup having at least one port;
said suction cup attached to said elongated shaft at a distal end;
wherein said pneumatic bulb is in pneumatic communication with said suction cup.

2. The golf disc retriever of claim 1, further comprising an elastic tubing extending from said pneumatic bulb to said suction cup.

3. The golf disc retriever of claim 2, wherein said elastic tubing is attached to said suction cup at said port.

4. The golf disc retriever of claim 1, wherein said suction cup is attached to said elongated shaft at a hinge.

5. The golf disc retriever of claim 1, wherein said elongated shaft includes a first telescoping member and a second telescoping member.

6. The golf disc retriever of claim 5, wherein said first telescoping member is concentrically disposed with said second telescoping member.

7. The golf disc retriever of claim 6, wherein said second telescoping member at least partially overlaps with said first telescoping member.

8. The golf disc retriever of claim 7, wherein said first telescoping member further comprises a slot extending longitudinally thereon.

9. The golf disc retriever of claim 8, wherein said second telescoping member includes a guide extending radially inward along at least a portion of the length of said second telescoping member.

10. The golf disc retriever of claim 9, wherein said guide of said second telescoping member is adapted to slideably engage with said slot of said first telescoping member.

11. The golf disc retriever of claim 10, further comprising one or more rings for fixing a desired extended length of said elongated shaft.

12. The golf disc retriever of claim 1, wherein said elongated shaft is adapted to extend to a distance for determining a game infraction.

13. The golf disc retriever of claim 12, wherein said distance is two meters.

14. The golf disc retriever of claim 5, comprising three telescoping members.

15. The golf disc retriever of claim 1, further comprising a valve for releasing pneumatic pressure.

16. The golf disc retriever of claim 15, wherein said valve is disposed on said bulb.

17. The golf disc retriever of claim 16, wherein said valve is disposed on said elongated shaft.

18. A golf disc retriever, comprising:
an elongated shaft extendable from a first collapsed length to a second expanded length;
a pneumatic actuator attached to said elongated shaft at a proximal end; and
a suction cup;
said suction cup attached to said elongated shaft at a distal end;
wherein said pneumatic bulb is in pneumatic communication with said suction cup.

19. The golf disc retriever of claim 18, wherein said pneumatic actuator is one of: a pneumatic bulb or a piston pump.

20. A golf disc retriever, comprising:
an elongated shaft extending from a first collapsed length to a second expanded length;
a suction cup,
and one of: a pneumatically sealed shaft, or a tubing;
wherein said pneumatically sealed shaft or tubing further includes an aperture for receiving an object to create a sealed pneumatic system used to retain a golf disc at said suction cup.
